(19) United States
(12) Patent Application Publication
(10) Pub. No.: US 2007/0182730 A1
(43) Pub. Date: Aug. 9, 2007

(54) Stereoscopic image display apparatus and program

(76) Inventors: Ken Mashitani, Osaka (JP); Goro Hamagishi, Osaka (JP); Satoshi Takemoto, Gifu (JP); Takatoshi Yoshikawa, Gifu (JP); Yoshihiro Hori, Gifu (JP); Keiji Horiuchi, Gifu (JP)

Correspondence Address: MCDERMOTT WILL & EMERY LLP, 600 13TH STREET, N.W., WASHINGTON, DC, 20005-3096, US

(21) Appl. No.: 10/558,478

(22) PCT Filed: May 26, 2004
(86) PCT No.: PCT/JP04/07184

§ 371 Date: Dec. 18, 2006

(30) Foreign Application Priority Data
May 28, 2003 (JP) 2003-150089
Nov. 14, 2003 (JP) 2003-384655

(51) Int. Cl. G06T 15/00

(52) U.S. Cl. 345/419

(57) ABSTRACT

Received electronic mail includes a text code and a pictographic character code, for example. A non-stereoscopic process is performed on an image of characters by the text code, and a stereoscopic process is performed on an image of a pictographic character by the pictographic character code. The stereoscopic process allows a viewer to observe a pictographic character representing a car LP shifted to left (shown with a dotted line) through the parallax barrier only with the right eye R, and to observe the pictographic character representing a car RP shifted to right (shown with a dotted line) through the parallax barrier only with the left eye L. Accordingly, the viewer perceives (stereoscopically views) the pictographic character representing a car at a position as if to be protruding from a display surface. Therefore, all the characters in a text are not simply stereoscopically displayed but the pictographic character, and the like, is stereoscopically viewed overlapped on characters to be non-stereoscopically viewed.

### TECHNICAL FIELD

The present invention relates to a stereoscopic image display apparatus and a program.

### BACKGROUND ART

As an art of stereoscopic viewing, there have been known various methods such as a stereoscopic viewing method without glasses using a parallax barrier, and a stereoscopic viewing method with glasses using polarizing glasses and liquid crystal shutter glasses, etc., and others. Furthermore, as images to be viewed stereoscopically, besides a live-action image, there is an image created by a 3-D rendering method in which an object arranged in a virtual space is projected on a plane surface and subjected to a rendering process by using computer graphics. In addition, a right-eye image and a left-eye image can be created by performing the rendering process in two viewpoints. Moreover, there is proposed a stereoscopic image receiving apparatus and a stereoscopic image system that generate a stereoscopic image on the basis of depth information extracted from a two-dimensional video signal and the two-dimensional video signal (see Japanese Patent Laying-open No. 2000-78611). If an image file composed of a two-dimensional image and depth information is created, a stereoscopic image can be generated when this file is opened. In addition, there is proposed a method in which two images are broadcast as an image of one channel and stereoscopic viewing can be performed on the receiver-side (see Japanese Patent Laying-open No. H10-174064). If an image file composed of two images is created, the stereoscopic image can be generated when the file is opened.

### DISCLOSURE OF THE INVENTION

### Problem to be Solved by the Invention

Incidentally, a file includes a file made by an electronic mail function of a personal computer and a mobile telephone, and a file made with a word processor, and the like. In such the files, it is desirable that a viewer is not simply allowed to view the whole characters to be displayed stereoscopically, but to view the characters to be displayed in a more effective stereoscopic manner.

Furthermore, when an HTML file is being rendered by a web browser, for example, if a mouse cursor is placed over an object such as banner advertising, the cursor is rendered (overwritten) on a nearer side than the object. At that time, as shown in FIGS. 20 (a) and (b), a shape of cursor may change. In a case where the object is displayed as if being protruded, the same images are prepared as many as the number of viewpoints, and the images are shifted in a horizontal direction so as to be displayed in order to be consistent with a stereoscopic method of a stereoscopic image display apparatus. In a two-eye parallax barrier method, two images are prepared, shifted in a horizontal direction, and displayed alternately every one line. This creates an image in which the characters are seen double. If a parallax barrier is arranged, images result in being separated and observed by a right eye and a left respectively, so that the object is seen as if being protruded.

In a case where the mouse cursor is placed over such the object displayed as if being protruded, if the cursor is overwritten, a sense of discomfort is generated. This is because, as shown in FIG. 21, the cursor supposed to be on a far side is displayed as if being located on a near side of the object only in a area where the cursor is placed over the object. There are some cases where the object includes an icon on a desk top in addition to such the object on an application. In a case of the icon, it is conceivable that there is a situation in which the icon serves as a cursor-side instead of an object-side. A similar situation occurs in a case where the icon is dragged to be overlapped on a stereoscopically displayed folder, a shortcut of an application, or a window, for example.

In view of the above circumstances, an object of the present invention is to provide a stereoscopic image display apparatus capable of not simply allowing characters in a document to be stereoscopically displayed but allowing a viewer to perform effective stereoscopic viewing. In addition, another object of the present invention is to provide a stereoscopic image display apparatus and a program that are capable of solving a sense of discomfort caused by a situation in which a cursor or the like originally supposed to be on a further side than a stereoscopically displayed object is displayed on a nearer side than the object.

### MEANS FOR SOLVING PROBLEM

In order to solve the above-mentioned problem, in a stereoscopic image display apparatus according to the present invention, an image of a character and an image of an object is used, a stereoscopic display-use rendering process is performed on at least one of the image of a character and the image of an object, and the object is stereoscopically viewed overlapped on a near side or a far side of a character displayed on a display and to be non-stereoscopically or stereoscopically viewed, or the object is non-stereoscopically viewed overlapped on the near side or the far side of the character displayed on the display and to be stereoscopically viewed.

In the above-described configuration, it is possible that only an object is stereoscopically viewed overlapped on the character, while the character in a document is non-stereoscopically viewed, for example. Accordingly, it is possible to allow a viewer to perform effective stereoscopic viewing.

A file to which the rendering process is applied may include a code specifying an image of a character and the image of an object. Or, the file to which the rendering process is applied may include a code specifying the image of a character and a pictographic character code specifying the image of an object. In addition, the file may include control information for controlling the stereoscopic display and may be a text file or a binary file. The stereoscopic image display apparatus may comprise a means for transmitting and/or receiving the file.

Image data of the character and image data of the object may be transparently composed at a certain rate. The image data of the character and the image data of the object are rendered on an area of another memory, and thereafter, may be composed on a graphic memory.

It may be configured that the object is displayed with animation and stereoscopically or displayed with animation and non-stereoscopically. A stereoscopic image display apparatus may include at least one of information for transforming the object, information for effacing the object, and information for moving the object. One or more pieces of the information may be used to generate a plurality of images of the object and the object is displayed with animation and stereoscopically or displayed with animation and non-stereoscopically. A stereoscopic image display apparatus may include at least one of dot data in which the object has been transformed, dot data in which the object has been effaced, and dot data in which the object has been moved. The object is displayed with animation and stereoscopically or displayed with animation and non-stereoscopically based on a plurality of dot data each of which forms a different image.

A control may be carried out such that more than one object is not stereoscopically displayed at the same time in a case where the object exists in plural. In a case where the object exists in plural, the objects are sequentially displayed with animation and stereoscopically and the objects which are waiting for being displayed with animation and stereoscopically are viewed stereoscopically or non-stereoscopically in a still state. An object which is not displayed stereoscopically or is not displayed with animation and stereoscopically may be displayed based on information instructing a state of the object.

Furthermore, the stereoscopic image display apparatus according to the present invention is a stereoscopic image display apparatus for generating a stereoscopic image and comprises a means for rendering images of a plurality of viewpoints so as to stereoscopically display an object, a means for performing a rendering process such that a cursor or an object is displayed in a moving manner on a screen according to operational information of a pointing device, a means for determining whether there is an overlap of the object to be stereoscopically displayed and, the cursor or the object; and a means for rendering the images of a plurality of viewpoints of the cursor or the object such that the cursor or the object is stereoscopically viewed on a nearer side than the object to be stereoscopically displayed when it is determined that there is the overlap.

The above-described stereoscopic image display apparatus may be configured that an expanding and rendering process is performed on the object to be stereoscopically displayed or the cursor to be stereoscopically displayed when the object to be stereoscopically displayed or the cursor to be stereoscopically displayed is stereoscopically viewed on a near side, and a reducing and rendering process is performed on the object to be stereoscopically displayed or the cursor to be stereoscopically displayed when the object to be stereoscopically displayed or the cursor to be stereoscopically displayed is stereoscopically viewed on a far side.

Furthermore, the stereoscopic image display apparatus according to the present invention is a stereoscopic image display apparatus for generating a stereoscopic image and comprises a means for rendering images of a plurality of viewpoints so as to stereoscopically display an object, a means for performing a rendering process such that a cursor or an object is displayed in a moving manner on a screen according to operational information of a pointing device, a means for determining whether there is an overlap of the object to be stereoscopically displayed, and the cursor or the object, and a means for performing a rendering process such that the cursor or the object is not displayed when it is determined that there is the overlap. In such the stereoscopic image display apparatus, a rendering process may be performed such that the cursor or the object is gradually erased.

Furthermore, the stereoscopic image display apparatus according to the present invention is a stereoscopic image display apparatus for generating a stereoscopic image and comprises a means for rendering images of a plurality of viewpoints so as to stereoscopically display an object, a means for performing rendering process such that a cursor or an object is displayed in a moving manner on a screen according to operational information of a pointing device, a means for determining whether there is an overlap of the object to be stereoscopically displayed, and the cursor or the object, and a means for performing a rendering process such that a transparent cursor having only a contour or a transparent object having only a contour is displayed as the cursor or the object when it is determined that there is the overlap.

Furthermore, the stereoscopic image display apparatus according to the present invention is a stereoscopic image display apparatus for generating a stereoscopic image and comprises a means for rendering images of a plurality of viewpoints so as to stereoscopically display an object, a means for performing a rendering process such that a cursor or an object is displayed in a moving manner on a screen according to operational information of a pointing device, a means for determining whether there is an overlap of the object to be stereoscopically displayed, and the cursor or the object; and a means for rendering all or a part of the cursor or the object by utilizing dot data of the object to be stereoscopically displayed when it is determined that there is the overlap.

In such the stereoscopic image display apparatuses, an expanding and rendering process may be performed on the object to be stereoscopically displayed when the object to be stereoscopically displayed is stereoscopically viewed on a near side, and a reducing and rendering process may be performed on the object to be stereoscopically displayed when the object to be stereoscopically displayed is stereoscopically viewed on a far side.

Furthermore, a program according to the present invention is a program for allowing a computer to function as a means for rendering images of a plurality of viewpoints so as to stereoscopically display an object, a means for performing a rendering process such that a cursor or an object is displayed in a moving manner on a screen according to operational information of a pointing device, a means for determining whether there is an overlap of the object to be stereoscopically displayed and the cursor or the object, and a means for rendering the images of a plurality of viewpoints of the cursor or the object such that the cursor or the object is stereoscopically viewed on a nearer side than the object to be stereoscopically displayed when it is determined that there is the overlap.

The above-described program may be so configured that the computer is allowed to function as a means for performing an expanding and rendering process on an object to be stereoscopically displayed or a cursor to be stereoscopically displayed when the object to be stereoscopically displayed or the cursor to be stereoscopically displayed is stereoscopically viewed on a near side, and for performing a reducing and rendering process on the object to be stereoscopically displayed or the cursor to be stereoscopically displayed when the object to be stereoscopically displayed or the cursor to be stereoscopically displayed is stereoscopically viewed on a far side.

Furthermore, a program according to the present invention is a program for allowing a personal computer to function as a means for rendering images of a plurality of viewpoints so as to stereoscopically display an object, a means for performing a rendering process such that a cursor or an object is displayed in a moving manner on a screen according to operational information of a pointing device, a means for determining whether there is an overlap of the object to be stereoscopically displayed, and the cursor or the object, and a means for performing a rendering process such that the cursor or the object is not displayed when it is determined that there is the overlap. In such the program, the computer may be allowed to function as a means for performing a rendering process such that the cursor or the object is gradually erased.

Furthermore, a program according to the present invention is a program for allowing a computer to function as a means for rendering images of a plurality of viewpoints so as to stereoscopically display an object, a means for performing a rendering process such that a cursor or an object is displayed in a moving manner on a screen according to operational information of a pointing device, a means for determining whether there is an overlap of the object to be stereoscopically displayed, and the cursor or the object, and a means for performing a rendering process such that a transparent cursor having only a contour or a transparent object having only a contour is displayed as the cursor or the object when it is determined that there is the overlap.

Furthermore, a program according to the present invention is a program for allowing a computer to function as a means for rendering images of a plurality of viewpoints so as to stereoscopically display an object, a means for performing a rendering process such that a cursor or an object is displayed in a moving manner on a screen according to operational information of a pointing device, a means for determining whether there is an overlap of the object to be stereoscopically displayed, and the cursor or the object, and a means for rendering all or a part of the cursor or the object by utilizing dot data of the object to be stereoscopically displayed when it is determined that there is the overlap.

In addition, in such the program, a computer may be allowed to function as a means for performing an expanding and rendering process on an object to be stereoscopically displayed when the object to be stereoscopically displayed is stereoscopically viewed on a near side, and for performing a reducing and rendering process on the object to be stereoscopically displayed when the object is stereoscopically viewed on a far side.

### EFFECT OF THE INVENTION

With the present invention, it is possible not simply to allow the whole characters to be stereoscopically displayed but allowing a viewer to perform effective stereoscopic viewing. Furthermore, there is an effect that it is possible to solve a sense of discomfort caused by a situation in which a cursor or the like originally supposed to be on a further side than a stereoscopically displayed object is displayed on a nearer side than the object, for example.

### BEST MODE FOR PRACTICING THE INVENTION

(Embodiment 1) Hereinafter, an embodiment of the present invention will be described with reference to FIG. 1 to FIG. 11. It is noted that a personal computer provided with communication environment will be exemplified below. Needless to say, it is possible to use mobile devices such as a mobile telephone, and the like, as a stereoscopic image display apparatus.

FIG. 1 shows one example of architecture of the personal computer (the stereoscopic image display apparatus). A CPU 1 is connected to a north bridge 2 having a system control function and a south bridge 3 having an interface function such as a PCI bus and an ISA bus. A video card 5 is connected to the north bridge 2 via a memory 4 and an AGP (Accelerated Graphics Port). Then, a USB (Universal Serial Bus) interface 6, a hard disk drive (HDD) 7, a CD-ROM device 8, and the like, are connected to the south bridge 3.

FIG. 2 shows a general video card 5. A VRAM (video memory) controller 5b performs controls such as writing rendering data to a VRAM 5a and reading the rendering data therefrom according to an instruction from the CPU 1 via the AGP. A DAC (D/A converter) 5c converts digital video data from the VRAM controller 5b to an analog video signal and feeds the video signal to a monitor 12 for the personal computer via a video buffer 5d. In such the image displaying process (rendering process), it is possible to perform a stereoscopic image displaying process for generating right-eye images and left-eye images and rendering these images alternately in a vertically striped shape.

The personal computer is provided with Internet connection environment and is capable of receiving files (for example, a document file, electronic mail, an HTML file, an XML file, and others) from a transmitting-side device configured as a server on the Internet, and the like. In addition, the personal computer is capable of displaying both a non-stereoscopic image and a stereoscopic image by providing a liquid crystal barrier for the monitor 12, for example. In a case where the stereoscopic image is formed by alternately arranging the right-eye image and the left-eye image in the vertically striped shape, for example, a vertical stripe-shaped light shielding area is formed on the liquid crystal barrier under a control of the CPU 1. Furthermore, when the stereoscopic image is displayed in a certain area on a screen (a window portion for file reproduction, or a certain image portion in an electronic mail document), a size and a formation position of the vertical stripe-shaped light shielding area may be controlled by the CPU 1 based on display coordinate and a size of the window or the certain image portion. A normal barrier (a barrier stripe is formed fixedly at a predetermined pitch) may be used instead of using the liquid crystal barrier. In addition, the personal computer is equipped with word processor software and electronic mail software and is capable of opening a file to display the image on the monitor 12.

Next, a stereoscopic viewing process of a file by the personal computer (software) will be described with reference to FIG. 3 to FIG. 11.

FIG. 3(a) shows text received by electronic mail, and FIG. 3(b) shows an image in which an object to be viewed stereoscopically is a pictographic character representing a car. The image (dot data) is received by electronic mail as an attached file, for example. In a stereoscopic viewing-nonapplicable device, if only the text data is displayed with ignoring the attached file, compatibility can be maintained. Furthermore, in a case of displaying the image with animation, the animation may be composed of a plurality of images in which positions of pictographic characters representing a car are slightly different one another. Or, the animation display may be performed based on control data for changing the positions of the pictographic characters representing a car, and the like. The control data may be added to the attached file, or may be owned by a receiving side in advance.

FIG. 4 shows an image displaying state on the display through a parallax barrier as an example. The pictographic character representing a car, which is the object to be viewed stereoscopically, is rendered in such a manner as to be overlapped on a text image, and is converted into two images. One is an image in which the pictographic character representing a car is shifted to the right (dots are shifted in the right direction) from an original rendering position for the stereoscopic viewing. The other is an image in which the pictographic character representing a car is shifted to the left (dots are shifted in the left direction) from the original rendering position for stereoscopic viewing.

FIG. 5 is a diagram showing a concept of stereoscopic viewing. The pictographic character representing a car is seen overlapped on the characters of electronic mail sentences to be viewed non-stereoscopically (or normal pictographic characters) on a different coordinate on an observation axis (Z-axis). However, as described above, the pictographic character representing a car appears to be on a different position on the Z-axis. Therefore, unlike in a case where the pictographic character representing a car is two-dimensionally (non-stereoscopically) displayed, a sense of discomfort is not caused even if the pictographic character is displayed overlapped on the characters of the mail sentences. In addition, in a case where the pictographic characters representing a car is moved by the animation display, even if a character “L” cannot be seen at a certain point of time, for example, the character “L” can be seen at another point of time. Accordingly, it is possible to read the text. In addition, in order to allow the non-stereoscopic characters to be seen through the pictographic character representing a car, which is to be viewed stereoscopically, the non-stereoscopic characters and the pictographic character may be rendered after obtaining various values thereof by carrying out the following calculation. That is, a composite R dot value is R equal to (=R1·M/100+R2·(1−M/100)) where an R (red) dot value of an image data of the two-dimensional characters is R1, an R (red) dot value of an image data of the pictographic character representing a car is R2, and a rate of the R1 is M %, for example.

FIG. 6 shows a principle of how the pictographic character representing a car is stereoscopically viewed, as an example. Herein, an observer observes the pictographic character representing a car LP shifted to the left (shown with a dotted line) through the parallax barrier only with the right eye R, and observes the pictographic character representing a car RP shifted to the right (shown with a dotted line) through the parallax barrier only with the left eye L. Accordingly, the observer perceives (stereoscopically views) the pictographic character representing a car at a position protruding from the display surface.

Herein, regarding a rendering onto a VRAM, for example, it is conceivable to render an image based on text data on a different first memory area (on a virtual screen), to render an image of the pictographic character representing a car on a different second memory area (on the virtual screen), and to compose both of the images to render the composed image on the VRAM. Such the processes are favorable for adopting pictographic characters having a size irrelevant to that of the characters, or for stereoscopically displaying the pictographic character moving around the entire screen. Furthermore, in a case where a plurality of stereoscopic pictographic characters are displayed, images thereof may be rendered on a further different memory area (on the virtual screen).

Next, a description will be made below, regarding a process of incorporating the pictographic characters into the text with corresponding to words input in creating text of electronic mail and the like.

For example, it is assumed that, if “JKLM” are input as an input character string and converted on text creation software as shown in FIG. 7, some candidates are displayed on the display. As the candidates, besides the two-dimensional pictographic character representing a car, an image in which the pictographic character representing a car is overlapped on the characters “JKLM” is included. The two-dimensional pictographic character representing a car, if a code (number) thereof is “1”, is described as <image icon=“1”>, for example. Or, the two-dimensional pictographic character representing a car may be described by inserting two bytes of existing ASCII characters (pictographic character code) between a pictographic character start code “S!” and a pictographic character end code “E”. If the code of the pictographic character representing a car is 00, it is described as “S! 00• E”.

Next, file configuration examples in a case where the pictographic character representing a car is overlapped on the characters of “JKLM” will be shown below.

File configuration example (1): In this configuration example, as shown in FIG. 8, text data 1 including the characters of “JKLM” and text data 2 specifying the pictographic character representing a car to be displayed overlapped on “JKLM” exist in one file. For example, two text data exist in a form like a layer 1 and a layer 2. Herein, if an image is displayed only based on the text data 1, the image is displayed as shown in FIG. 8 (a). Then, a character string “S! 00• E” exists in the text data 2, for example. When a stereoscopic viewing process is performed by recognizing this character string (code) and reading out data of the two-dimensional pictographic character image, a stereoscopic viewing rendering is performed as shown in FIG. 8(b). That is, software for opening a mail file reads out an image file of the pictographic character based on the character string “S! 00• E”. Even if the image file of the two-dimensional pictographic character representing a car is one, it is possible to perform a stereoscopic animation display by a process for changing display positions of the pictographic characters and a process for expanding/reducing the pictographic characters on a side of a device for receiving the electronic mail. Furthermore, a description start position “S! 00• E” corresponds to a text position of “J” of “JKLM”, and becomes an index for defining a base display position of the pictographic character representing a car on an animation image in FIG. 8 (b).

It is noted that a portion other than the character string “S! 00• E” is a space. A stereoscopic viewing-nonapplicable device, when receiving the text data 1 and the text data 2 by electronic mail, can display only the text by ignoring the text data 2. In addition, when there is a rule that the text data 2 is a pictographic character file for stereoscopic viewing, the description of the text data 2, in a case of the pictographic character representing a car, may be a description in which only “00” is described after a certain number of spaces.

The text data 1 and the text data 2 may be separated to be different files. That is, a process described below may be performed. The process is to designate the text data 1, in which only the character strings “JKLMOPQR . . . ” are aligned, as a body text file, and to designate the text data 2, in which spaces of which number is equal to that of characters from a start position of a character string to a character position of “J” are inserted and “S! 00• E” or only “00” is described after the spaces, as an attached file. The stereoscopic viewing-nonapplicable device, when receiving the body text file and the attached file by electronic mail, can display only the text by ignoring the attached file.

Furthermore, as shown in FIG. 8 (a), in a case that the character string “JKLM” continues to a next line, a rendering process may be performed so that the position of “K” becomes a display reference position of the pictographic character. Or, a linefeed process may be performed automatically so that the character string “JKLM” is displayed in one line. In the above-described example, a portion of the pictographic character representing a car is created horizontally in a size for four characters so as to adjust to the four characters of “JKLM”. Information on the size for four characters can also be indicated by a description such as “S! 00• E-4”, for example. In a case where the image in which the pictographic character representing a car is overlapped on the characters “JKLM” is selected from the above-described candidates, the text creation software, regarding the text data 1, determines whether or not the four characters of “JKLM” are contained within one line, and if the characters continue to the next line, inserts line feeds and creates the text file so that the characters “JKLM” are displayed from the beginning of the new line. In addition, the text creation software, regarding the text data 2, inserts spaces so as to correspond to the line feeds and describes “S! 00• E-4”, and the like, after the spaces.

As described above, if a display area of the pictographic character representing a car displayed with animation and stereoscopically is allowed to have the size for four characters, it is possible to realize a stereoscopic animation display within a range in which the pictographic character representing a car corresponds to the four characters “JKLM”. On the other hand, instead of setting the size for four characters so as to correspond to the four characters “JKLM”, when displaying the pictographic character representing a car with animation and stereoscopically, the display area of the pictographic character representing a car may be set to the size for four characters with respect to one character “C”, for example. As shown in FIG. 9, for example, (1) the stereoscopic animation display may be overlapped on a center of the four characters including “C” as a first character of the four, (2) the stereoscopic animation display may be overlapped on a center of the four characters including “C” as a center character of the four, or (3) spaces for three characters may be inserted so as to adjoin the character “C”. The text creation software may create the text data 1 according to any one of the above-described methods (1) to (3). Furthermore, the text creation software, regarding the text data 2, may insert spaces in such a manner as to correspond to any one of the above-described methods (1) to (3) and describe “S! 00• E-4”, etc., after the spaces.

The stereoscopic animation display can be performed by a plurality of images prepared in advance. In addition, at least one of information for transforming the pictographic character representing a car (object), information for effacing the object, and information for moving the object may be prepared, and the object may be displayed with animation and stereoscopically or displayed with animation and non-stereoscopically by generating a plurality of images using one or more pieces of the above mentioned information. Furthermore, at least one of dot data in which the pictographic character representing a car (object) has been transformed, dot data in which the object has been effaced, and dot data in which the object has been moved are prepared, and the object may be displayed with animation and stereoscopically or displayed with animation and non-stereoscopically based on a plurality of dot data each of which forms a different image.

File configuration example (2): In the above described example, a file example having the text data 1 and the text data 2 is shown. However, a file configuration in which the pictographic character code is arranged in one text data may be adopted. For example, the pictographic character code may be arranged in the text data in a form such as “JKLM S! 00• E-4 N . . . ”. In addition, the file may include format data (control information). The format data may be stored in a text format (text file), or stored in a form other than the text format (binary file) such as a word processor file. In the format data, for example, it is conceivable that a start position of a character is indicated by a position corresponding to an end position of a character immediately anterior thereto, and the character position of the character anterior to the pictographic character code is indicated by a negative value. To be more specific, as shown in FIGS. 10 (a) and (b), an area enclosed by a square is the area given to each character, and if the character positions of “K” to “J”, “L” to “K”, and “M” to “L” are indicated by 0 (zero), the areas of each of the characters are arranged in contact with one another when displayed (actually, the square is not displayed).

Moreover, a character distance between “M” and the “pictographic character” (a display position of the pictographic character) is −W (M). W (M) is a horizontal width of the character area of “M”. Then, the “pictographic character” is displayed in a position overlapped on “M”. In this case, if W (pictographic character) which is the width of the pictographic character is wider than W (M), the pictographic character is displayed as shown in FIG. 10(a). The position of N may be 0 (zero). In a case where the width of “N” is different from that of the “pictographic character”, the display position of the pictographic character may be defined as, −{W (M)/2+W (pictographic character)/2}, such that the center of “N” and the “pictographic character” are coincided and overlapped. Or, in a case where W (pictographic character) which is the width of the pictographic character is narrower than W (M), the display position of the pictographic character may be −W (pictographic character). On the other hand, in a case where a size of the pictographic character is large, the display position of the pictographic character may be defined as, −{W(M)+W(L)}. In this case, the position of “O” may be {W(M)+W(L)−W (pictographic character)} in a case where the size of the pictographic character is smaller than W(M)+W(L), and may be 0 (zero) in a case where the size of the pictographic character is larger than W(M)+W(L).

The format data may include more detailed information. When there is the format data shown in FIG. 11, the “pictographic character” in full size moves on a range “AB, CDEFGHIJKLM.” which is wider than the width of the pictographic character itself. The character position (W0) is as described above with respect to the characters and indicates an initial position with respect to the pictographic character. The initial position is utilized in a sequence (M) described later. A movement start position (W1) indicates a first position from which a movement of the pictographic character starts. A movement end position (W2) indicates a last position at which the movement of the pictographic character ends. A moving speed (S) indicates the number of characters as an amount that the pictographic character moves per second. The amount that the pictographic character moves per second may be defined by a width (the same unit as that of W). In a case where the width of each character is not equal, a movement of the pictographic character becomes smoother when the amount that the pictographic character moves per second is defined by the width. Moving methods (N) are defined such that “1” is a reciprocating movement, “2” is a movement from left to right, and “3” is a movement from right to left.

The sequence (M) defines an order of the movement when there are a plurality of moving pictographic characters. When a certain pictographic character is moving, other pictographic characters suspend at a position defined by the character position (W0). That is, after a series of movement of one pictographic character, the next pictographic character starts to move. Accordingly, a plurality of pictographic characters do not move simultaneously, so that it is possible to prevent the movement of the characters from appearing to be in disorder. The pictographic character of M=1 moves first, and the pictographic character of M=2 moves second. The pictographic character of M=0 may move at all times. A stereoscopic degree of the pictographic characters (Q) shows the stereoscopic degree at each position of the pictographic characters. When the stereoscopic degree is negative, the pictographic characters are seen on a far side of the screen, and when the stereoscopic degree is positive, the pictographic characters are seen on a near side of the screen as if the pictographic characters are protruded forward. The larger a numerical value of the stereoscopic degree, the stronger a sense of depth or a sense of protrusion.

The stereoscopic degree defines a shift amount of the dots in a case where two pictographic characters, one for a right eye and the other for a left eye, are obtained from one two-dimensional pictographic character by a process of dot shift on a side of the device for receiving a file. Even when there is pictographic character dot data in which the pictographic character for the right eye and the pictographic character for the left eye are already composed, the stereoscopic degree (Q) can be used when the dot data is divided into a plurality of pictographic dot data once and recomposed. The stereoscopic degree (Q), instead of being determined corresponding to each character position, can be also defined such that, within a movement range of pictographic characters, Q=1 means “to move from the far side to the near side”, Q=2 means “to move from the near side to the far side”, and Q=3 means “to move repeatedly from the far side to the near side, and vice versa”, for example. At the initial position, the pictographic characters may be displayed non-stereoscopically or stereoscopically.

In a case of an animation image, it may be defined that a first frame is used or a frame to be used is specified when displaying the still image. It is preferable that the frame to be used is written in a header, or the like. In a case where there are a plurality of pictographic characters, the pictographic characters waiting to be displayed with animation and stereoscopically are viewed stereoscopically or non-stereoscopically in a still state, and in this case, the pictographic characters which are not displayed with animation and stereoscopically (pictographic characters in a waiting state) may be displayed based on information for instructing the state of the object (information for instructing the object are viewed non-stereoscopically or stereoscopically). This information for instructing or the frame to be used may be written in the header or the format data, and the like.

It is noted that, in the above-described example, the pictographic character as an object is stereoscopically viewed overlapped on the characters to be viewed non-stereoscopically. However, both the characters and the object may be stereoscopically viewed respectively at different positions on the Z-axis. Or, the characters may be stereoscopically viewed overlapped on the object to be viewed non-stereoscopically. Furthermore, the stereoscopic image display apparatus may be configured as a digital broadcasting receiver capable of receiving data broadcasting (a BML file, etc.) and displaying an image, and in addition, as a personal computer provided with communication environment and an image display function, a mobile device, and the like.

(Embodiment 2) Hereinafter, the stereoscopic image display apparatus and the program according to Embodiment 2 of the present invention will be described with reference to FIG. 12 to FIG. 19. The hardware is similar to that in FIG. 1 and FIG. 2, so that the description thereof is omitted.

A stereoscopic viewing-use rendering process of a file by a personal computer (browser software) will be described with reference to FIG. 12 and FIG. 13. FIG. 12 shows an example in which the characters such as “ABCDE” are stereoscopically displayed (seen as if being protruded). The left-eye image is shifted to the right side with respect to the right-eye image by predetermined dots, and the two images are composed. As a result, a stereoscopic viewing-use image is produced. Herein, a shift amount of a character portion, “ABCDE” is calculated based on a description of the file, for example, and data for displaying the left-eye image and data for displaying the right-eye image in FIG. 12 are generated. A description start position of “ABCDE” is specified by an X-coordinate indicated by <start x>100</start x> and a Y-coordinate indicated by <start y>50</start y>, which are described in the file, for example. Then, a process in which dot data constituting the data for displaying the left-eye image and the dot data constituting the data for displaying the right-eye image are written alternately (a right-eye dot and a left-eye dot are written alternately one by one in a horizontal direction as a displaying image) from a dot data storage position on the VRAM, which is corresponding to the coordinates, is performed.

FIG. 13 shows a description example of a file for stereoscopically displaying the character string of “ABCDE”. The personal computer (browser software) determines a description portion indicating a stereoscopic viewing-use process out of the descriptions in the file. In the example in FIG. 13, a portion sandwiched by <3d> and </3d> is determined to be the description portion indicating the stereoscopic viewing-use process. Then, a phase shift amount and a shift direction of a target object are determined based on the description portion indicating the stereoscopic viewing-use process. In the example of FIG. 13, there is a description of <zurashi L X>8</zurashi L X>, so that it is determined that the phase shift amount of left eye-use character image is eight dots to the right side based on the description. It is noted that the phase shift of a right eye-use character image is not performed in this description example. The personal computer (browser software) determines target characters, the phase shift amount, and the shift direction, and performs processes for rendering the right-eye image and the left-eye image.

Incidentally, a driver of a pointing device (hereinafter, referred to as a mouse) when detecting a movement of the mouse, transmits a detected content to an API (Application Programming Interface) prepared by an OS (Operating System). Then the OS moves (performs the rendering process) a mouse cursor and transmits mouse position information as a message to a browser (much the same is true on another applications). In addition, the OS normally prepares a plurality of cursors. For example, cursors such as “text”, “wait”, “help”, “hand”, and the like, are prepared, and it is possible to specify the cursor of desired shape corresponding to a predetermined event according to the description of the file.

When determining that a cursor is located on a rendering area of “ABCDE”, the personal computer (the CPU, the browser, the OS) adopts the cursor “hand”, for example, to perform processes for rendering the right-eye image and the left-eye image regarding the image of the cursor “hand”. If it is impossible for the browser to perform a rendering control of the cursor, the stereoscopic rendering of the cursor may be assigned to a side of the OS. In this case, the OS prepares a cursor “3Dhand”, for example, and the browser may request the OS to perform a display adopting this cursor. When the cursor “3Dhand” is specified, the OS executes two rendering processes of an original cursor and a cursor of which phase is shifted. The phase shift amount may be applied from the browser to the OS. Herein, there is a description such as <zurashi L X>8</zurashi L X> for the stereoscopic viewing of “ABCDE”, and if the cursor “hand” is to be displayed protruding much nearer than the “ABCDE”, a calculation such as 8+(plus) 1=(is equal to) 9 is carried out, and the rendering process is performed, determining that the phase shift amount of the left-eye image of the cursor “hand” image is nine dots to the right side. It is noted that the phase shift amount of the left-eye character image of the cursor “hand” image may be a value equal to the phase shift amount of “ABCDE”.

The rendering by the above-described process is shown as an example in FIG. 14. In addition, procedure for this process is put in order as follows.

1) Generate a stereoscopic image of the cursor from the image of the cursor.

2) Render a composed image of the object.

3) Render a stereoscopic image of the cursor.

When generating the stereoscopic image of the cursor, it is only necessary to shift the image of the cursor by an amount equal to or more than the shift amount of the object. If a sudden movement of the cursor causes a sense of discomfort, the cursor may be gradually moved to a near side. For example, the above-described calculation of 8+(plus) 1=(equal to) 9, and the like, is carried out and let the maximum value of x be 9. Then, a process such as the initial value x=(is equal to) 0 and x=(is equal to) x+(plus) 1 is carried out after displaying the cursor for a predetermined time period, and the rendering process in which the phase shift amount of the left-eye image of the cursor “hand” is x dots to the right may be performed for every predetermined time. A depth relationship between the object and the cursor is a relative relationship, and therefore, the object may be displayed in such a manner as to move to the far side, instead of changing the cursor position on the Z-axis. If the shift direction in composing the objects is reversed, the objects move to the further side than the cursor. The objects, too, may be moved gradually.

Next, another process example will be described. The process example here, as shown in FIG. 15, is an example in which the cursor is placed beneath the object (further side) when being placed over a display area of the object (banner advertising) displayed as “ABCDE”. Specific processes for this can be realized by a process for determining an overlap of the display area of the object and that of the cursor, and a process for always rendering the target object for the stereoscopic viewing after carrying out the rendering process of a figure of the cursor when the overlap is determined, for example.

Furthermore, another process example will be described. The process example here is an example in which the cursor is erased when being overlapped on the display area of the object displayed as “ABCDE”. In this case, a viewer has an impression that the cursor suddenly disappears rather than hides. Therefore, it is preferable to insert animation processes such that the cursor gradually becomes smaller and disappears, or the cursor disappears little by little like a cloud does, etc. On the other hand, when the cursor appears, processes such that the cursor gradually becomes larger, or the cursor gradually appears from a substance like a fog may be performed, for example.

FIGS. 16 (a), (b), and (c) show a state in which the cursor is gradually erased. As specific processes for this, a cursor of which figure is similar to the original cursor but of which size is different is prepared in advance, or an expanding/reducing process (dot interpolation/dot thinning out process) is performed on the figure of the cursor. Then, a process for determining an overlap of the display area of the object and that of the cursor, and a process for gradually rendering a smaller cursor for every predetermined time period when the overlap is determined, are performed.

However, the process in which the cursor is hidden as described in the above-mentioned FIG. 15 and FIG. 16 is quite inconvenient, because it becomes impossible to find the position of the cursor depending on the size of the object.

Such the inconvenience, as shown in FIG. 17 and FIG. 18, can be solved by making a color and a pattern of the cursor same as those of the object when the cursor is overlapped on the display area of the object displayed as “ABCDE”.

Specific processes for this are composed of (1) a process for determining the overlap of the display area of the object and that of the cursor, (2) a process for rendering the composed image of the object, (3) a process for rendering the cursor, and (4) a rendering process for applying the color and the pattern of the object to a portion where the cursor is overlapped on the display area of the object. For example, by carrying out a process for taking out the already-written image data (that is, a part of image data of the object which has been already written) corresponding to predetermined vertical dots times predetermined horizontal dots in an approximately center position of the figure of the cursor to be rendered and rendering repeatedly so as to fill in the figure of the cursor, the color and the pattern of the cursor become approximately the same as those of the object. As shown in FIG. 18, it is possible to apply the same color and pattern to only the overlapping portion.

Or, the specific processes are composed of (1) the process for determining the overlap of the display area of the object and that of the cursor, (2) a process for cutting out the image of the overlapping portion from the composed image of the object, (3) the process for rendering the composed image of the object, (4) the process for rendering the cursor, and (5) a process for rendering the cut-out image on the portion where the cursor is overlapped. Herein, the image data is rendered from the left to the right, the already-written image data, corresponding to from a left-side end to a right-side end of the figure of the cursor to be rendered, is rendered on another memory, for example. In the above-described process (5), it is possible to paste the cut-out image by rendering on the cursor the image data rendered on the memory.

Or, the specific processes may be composed of (1) the process for determining the overlap of the display area of the object and that of the cursor, (2) the process for rendering the composed image of the object, (3) a process for rendering a transparent cursor (the cursor formed of the image data having only a contour) when the overlap is determined. As shown in FIG. 18, such the process makes it possible to apply the same color and pattern of the object only to the overlapping area.

Though the display processes shown in above-described FIG. 17 and FIG. 18 are not a perfect solution to the sense of discomfort caused as a result that the cursor supposed to be at the back of the object is displayed as if being at the front of the object only in the portion where the cursor is overlapped on the object, the sense of discomfort felt by a viewer is alleviated due to a visual trick.

Incidentally, in a case where the object is viewed stereoscopically as if being protruded, as shown in FIG. 19, a sensory object-width F becomes narrower than an character original width D. Then, the browser executes a process for converting the size of the characters “ABCDE” as a target of the stereoscopic viewing into double, for example. After this process, the process for rendering the right-eye image and the left-eye image (a process for shifting the phase, a process for writing alternately) is performed.

As shown in FIG. 19, there is a relation such as D:(A+B)=F:B, C:A=E:B, and accordingly, F/D=E/(E+C). The size of characters becomes E/(E+C) times (shrink) due to the protrusion, so that the size of the characters is multiplied by (E+C)/E in advance and displayed. E is a fixed number of approximately 65 mm (millimeters). In a case where a phase shift amount equivalent to a parallax amount C=65 mm (millimeters) is set, for example, a sensory character size becomes one-half, so that the size of the characters is multiplied by two in advance and rendered.

Herein, the personal computer (the browser) retains dot pitch information of the monitor 12 thereof (includes a table with which dot pitch is obtained based on the screen inch size and the screen resolution, and the dot pitch (mm) can be obtained by making a user input the screen inch size and the screen resolution). The personal computer (the browser) evaluates a value of (E+C)/E based on C (mm) evaluated by multiplying the phase shift amount (the number of dots) by the dot pitch and E=65 mm, and performs the dot interpolation process on the original characters based on the value. Or, the personal computer (the browser) determines the size of the characters equivalent to the size obtained by multiplying the original size of the characters by the value of (E+C)/E, obtains the dot data of “ABCD” having the determined size of the characters, and renders the characters. Such the process can be adopted for the cursor to be stereoscopically displayed.

It is noted that the case where the cursor is overlapped on the object which is stereoscopically displayed is shown in the above-described examples. However, also when an icon dragged with the cursor, and others (object) are overlapped on the object which is stereoscopically displayed, processes similar to that performed on the cursor may be performed on the object such as the icon and others.

### BRIEF DESCRIPTION OF THE DRAWINGS

FIG. 1 is a diagram showing an embodiment of the present invention and a block diagram showing an architecture example of a personal computer;

FIG. 2 is a diagram showing the embodiment of the present invention and a block diagram showing a configuration example of a video card;

FIG. 3 is a diagram showing the embodiment of the present invention;

FIG. 3(a) shows text data;

FIG. 3(b) is a descriptive diagram showing animation image data;

FIG. 4 is a diagram showing the embodiment of the present invention and a descriptive diagram showing a display seen through a parallax barrier;

FIG. 5 is a diagram showing the embodiment of the present invention and a descriptive diagram showing a concept of stereoscopic viewing;

FIG. 6 is a diagram showing the embodiment of the present invention and a descriptive diagram showing a principle of stereoscopic viewing;

FIG. 7 is a diagram showing the embodiment of the present invention and a descriptive diagram showing an example of character conversion;

FIG. 8 is a diagram showing the embodiment of the present invention and a descriptive diagram showing text data;

FIG. 9 is a diagram showing the embodiment of the present invention and a descriptive diagram showing an example of a positional relationship between pictographic characters and characters to be non-stereoscopically viewed;

FIG. 10 is a diagram showing the embodiment of the present invention;

FIG. 10(a) is a descriptive diagram showing a display example of text data and format data;

FIG. 10(b) is a descriptive diagram showing a start position and an end position of a character area;

FIG. 11 is a diagram showing the embodiment of the present invention and a descriptive diagram showing a corresponding relationship of text data and detailed format data;

FIG. 12 is a diagram showing the embodiment of the present invention and a descriptive diagram showing a stereoscopic viewing-use rendering process of an object by a personal computer (browser software);

FIG. 13 is a diagram showing the embodiment of the present invention and a descriptive diagram showing a description example of a file;

FIG. 14 is a diagram showing the embodiment of the present invention and a situation in which a cursor is stereoscopically displayed as if being more protruded than an object to be stereoscopically displayed;

FIG. 15 is a diagram showing the embodiment of the present invention and a descriptive diagram showing a display example of a cursor with respect to an object to be stereoscopically displayed;

FIG. 16 is a diagram showing the embodiment of the present invention;

FIGS. 16(a), (b), and (c) are descriptive diagrams showing display examples of cursors with respect to objects to be stereoscopically displayed;

FIG. 17 is a diagram showing the embodiment of the present invention and a descriptive diagram showing a display example of a cursor with respect to an object to be stereoscopically displayed;

FIG. 18 is a diagram showing the embodiment of the present invention and a descriptive diagram showing a display example of a cursor with respect to an object to be stereoscopically displayed;

FIG. 19 is a diagram showing the embodiment of the present invention and a descriptive diagram showing a principle of stereoscopic viewing;

FIG. 20 is a diagram showing the embodiment of the present invention;

FIGS. 20(a) and (b) are descriptive diagrams showing general display examples of cursors; and

FIG. 21 is a diagram showing the embodiment of the present invention and a descriptive diagram showing a situation in which a cursor which is originally supposed to exist on a further side than an object displayed stereoscopically is displayed on a nearer side than the object.

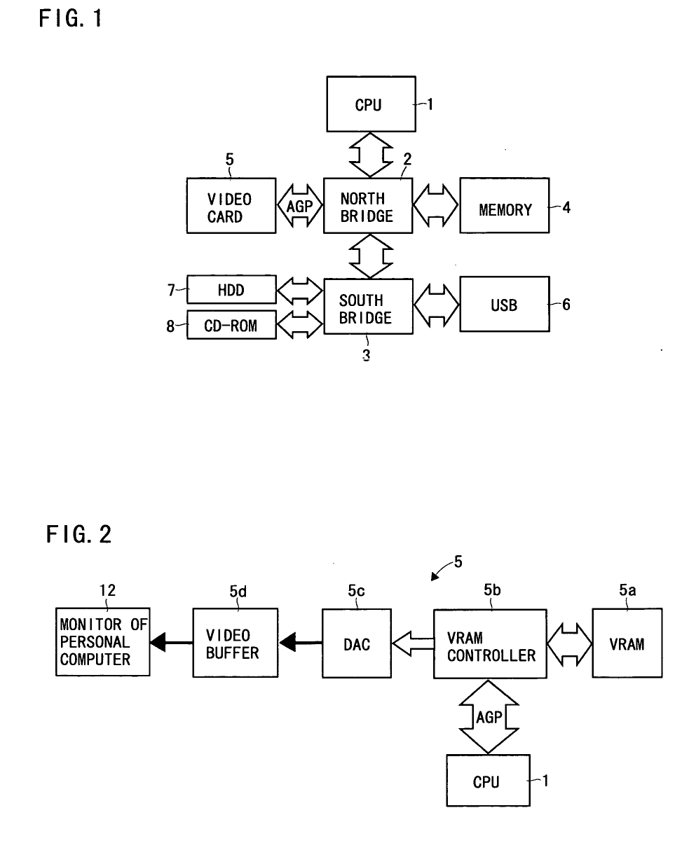

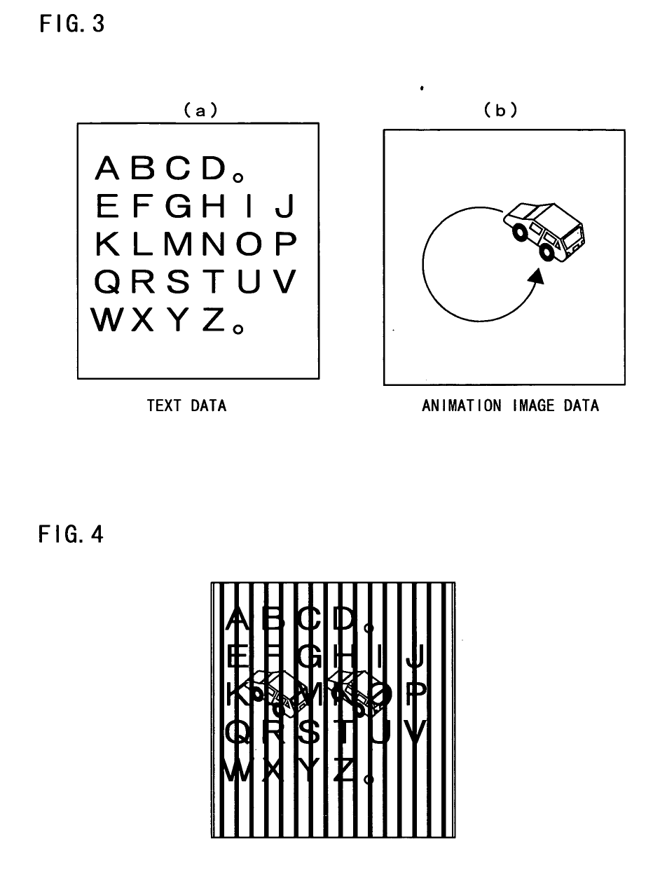

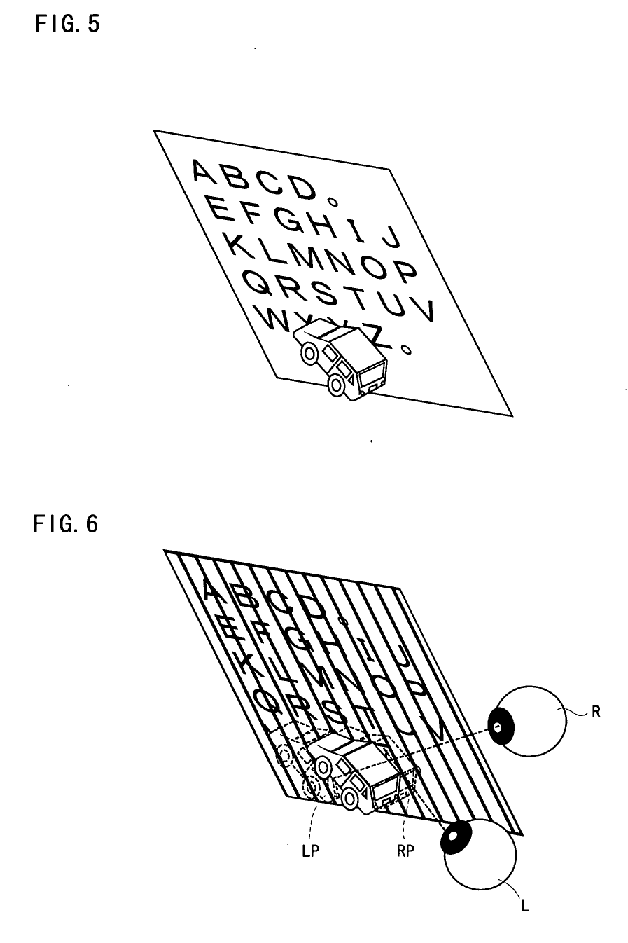

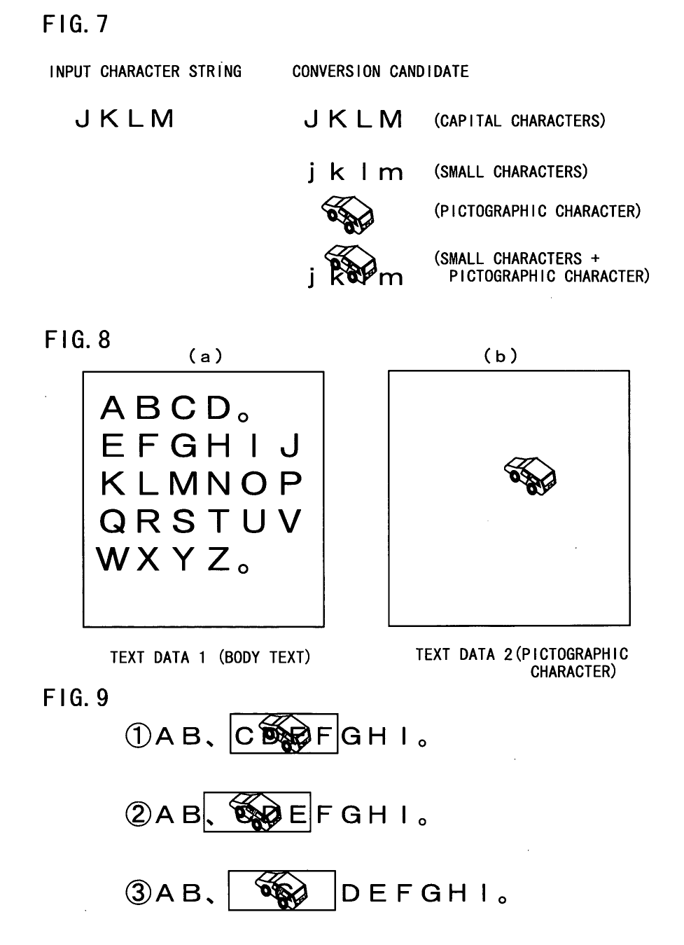

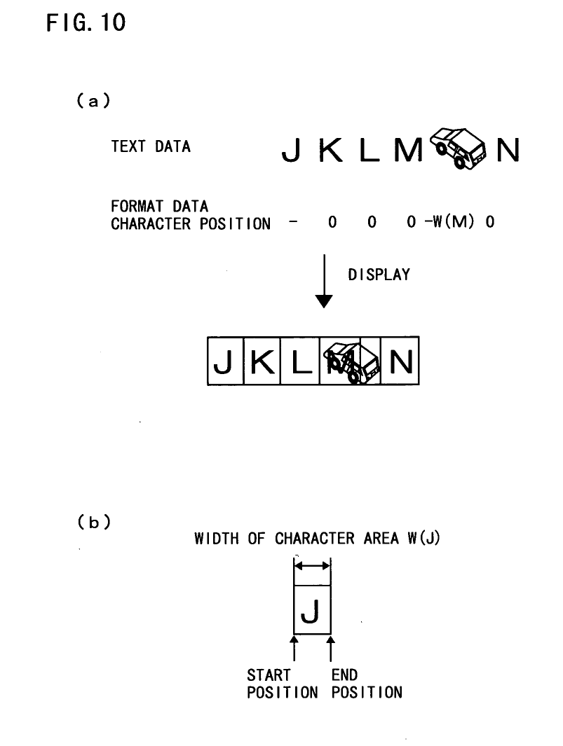

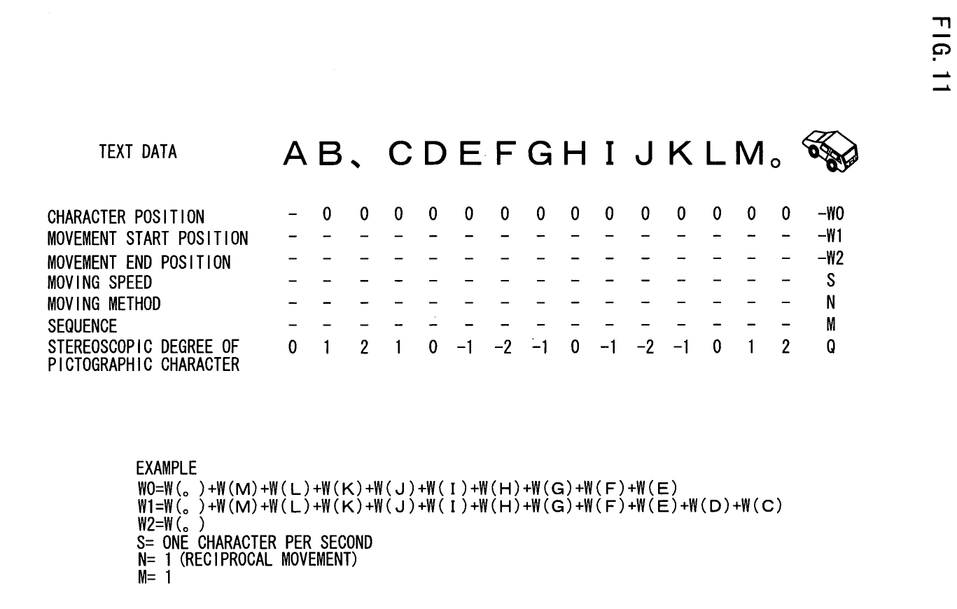

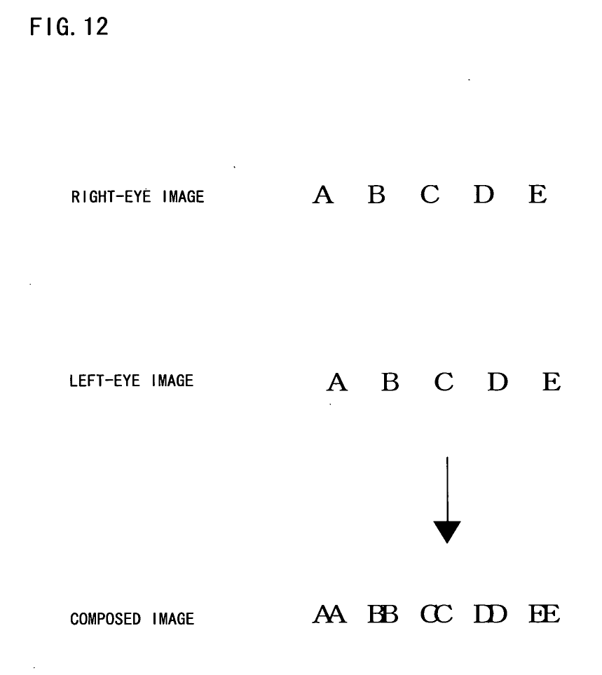

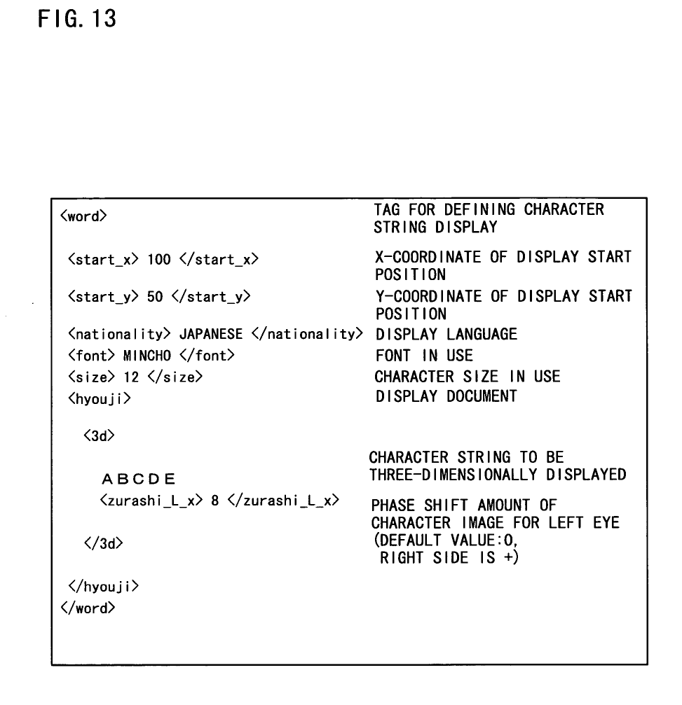

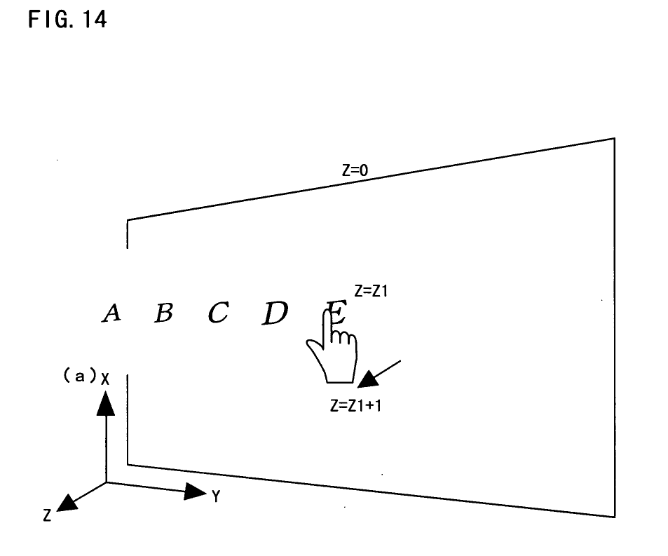

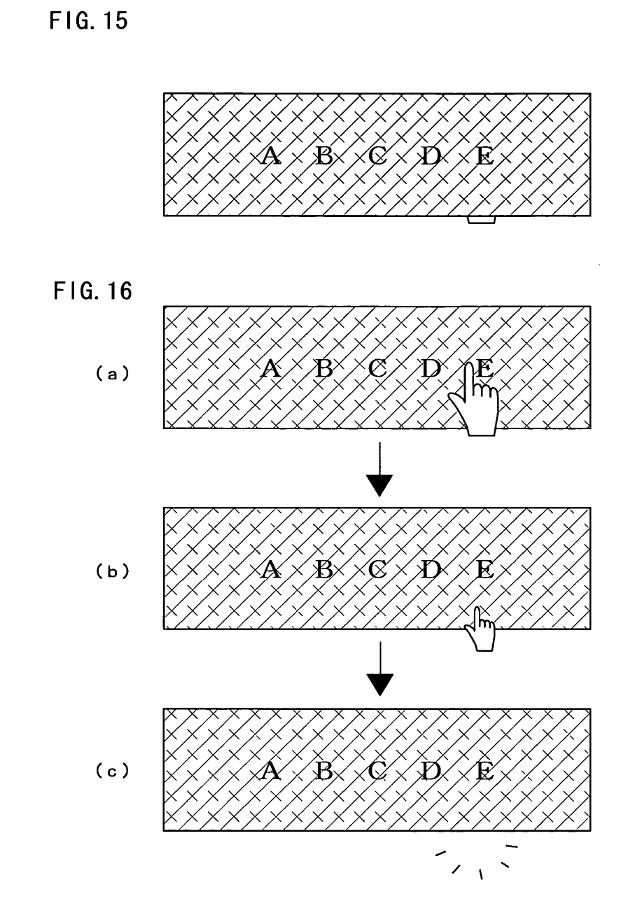

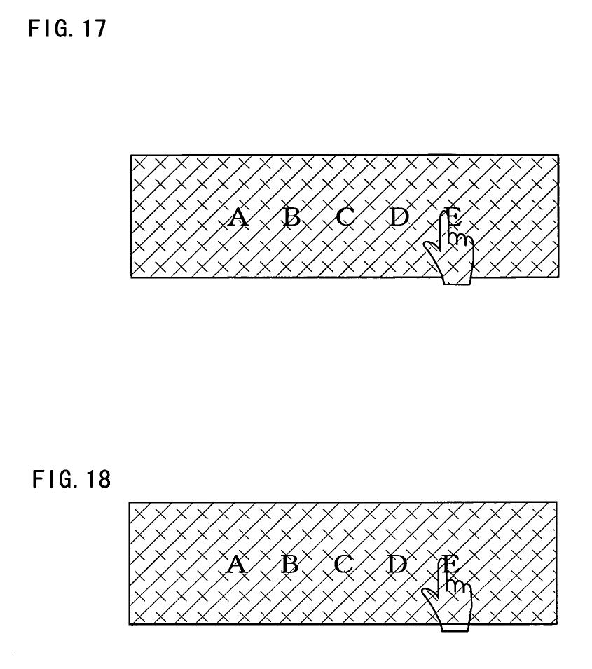

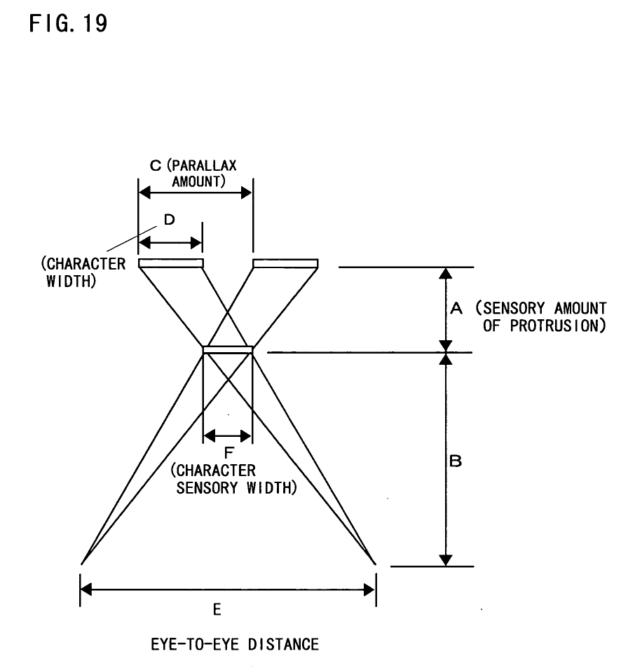

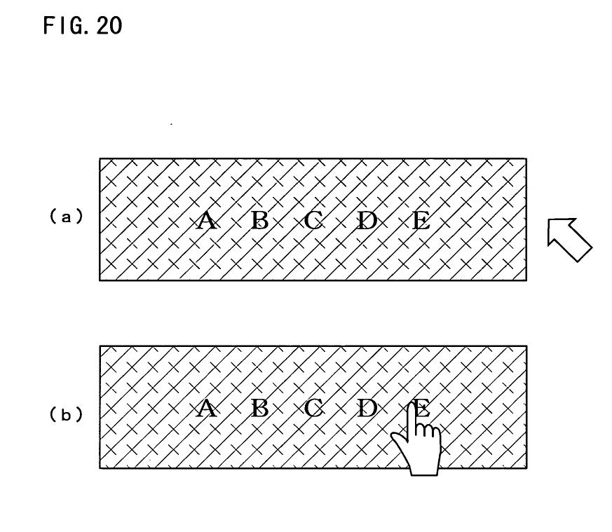

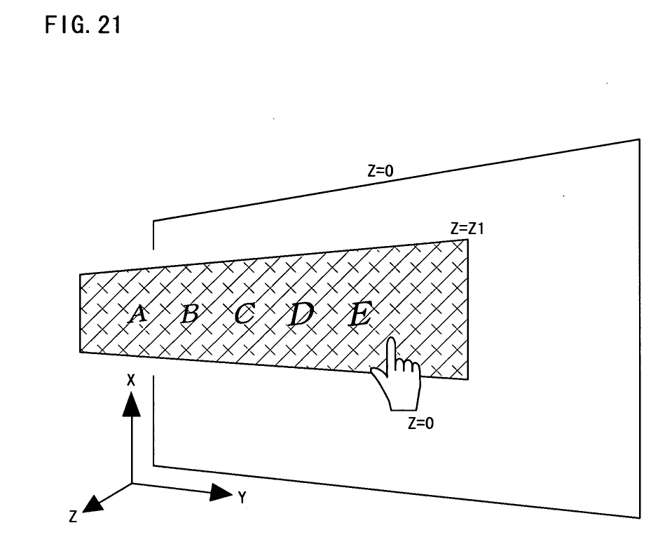

What is claimed is:

1. A stereoscopic image display apparatus, wherein an image of a character and an image of an object is used, a stereoscopic display-use rendering process is performed on at least one of the image of a character and the image of an object, and the object is stereoscopically viewed overlapped on a near side or a far side of a character displayed on a display and to be non-stereoscopically or stereoscopically viewed, or the object is non-stereoscopically viewed overlapped on the near side or the far side of the character displayed on the display and to be stereoscopically viewed.

2. A stereoscopic image display apparatus according to claim 1, wherein a file to which the rendering process is applied includes a code specifying an image of a character and the image of an object.

3. A stereoscopic image display apparatus according to claim 1, wherein a file to which the rendering process is applied includes a code specifying the image of a character and a pictographic character code specifying the image of an object.

4. A stereoscopic image display apparatus according to claim 2 or 3, wherein the file includes control information for controlling the stereoscopic display and is a text file or a binary file.

5. A stereoscopic image display apparatus according to any one of claims 2 to 4, comprising a means for transmitting and/or receiving the file.

6. A stereoscopic image display apparatus according to any one of claims 1 to 5, wherein image data of the character and image data of the object are transparently composed at a certain rate.

7. A stereoscopic image display apparatus according to any one of claims 1 to 6, wherein the image data of the character and the image data of the object are rendered on an area of another memory, and thereafter, are composed on a graphic memory.

8. A stereoscopic image display apparatus according to any one of claims 1 to 7, wherein the object is displayed with animation and stereoscopically or displayed with animation and non-stereoscopically.

9. A stereoscopic image display apparatus according to claim 8, including at least one of information for transforming the object, information for effacing the object, and information for moving the object, wherein one or more pieces of the information are used to generate a plurality of images of the object and the object is displayed with animation and stereoscopically or displayed with animation and non-stereoscopically.

10. A stereoscopic image display apparatus according to claim 8, including at least one of dot data in which the object has been transformed, dot data in which the object has been effaced, and dot data in which the object has been moved, wherein the object is displayed with animation and stereoscopically or displayed with animation and non-stereoscopically based on a plurality of dot data each of which forms a different image.

11. A stereoscopic image display apparatus according to any one of claims 1 to 10, wherein a control is carried out such that more than one object is not stereoscopically displayed at the same time in a case where the object exists in plural.

12. A stereoscopic image display apparatus according to any one of claims 8 to 10, wherein, in a case where the object exists in plural, the objects are sequentially displayed with animation and stereoscopically and the objects which are waiting for being displayed with animation and stereoscopically are viewed stereoscopically or non-stereoscopically in a still state.

13. A stereoscopic image display apparatus according to claim 11 or claim 12, wherein an object which is not stereoscopically displayed or is not displayed with animation and stereoscopically is displayed based on information instructing a state of the object.

14. A stereoscopic image display apparatus for generating a stereoscopic image, comprising:
a means for rendering images of a plurality of viewpoints so as to stereoscopically display an object;
a means for performing a rendering process such that a cursor or an object is displayed in a moving manner on a screen according to operational information of a pointing device;
a means for determining whether there is an overlap of the object to be stereoscopically displayed and, the cursor or the object; and
a means for rendering the images of a plurality of viewpoints of the cursor or the object such that the cursor or the object is stereoscopically viewed on a nearer side than the object to be stereoscopically displayed when it is determined that there is the overlap.

15. A stereoscopic image display apparatus according to claim 14, wherein an expanding and rendering process is performed on the object to be stereoscopically displayed or the cursor to be stereoscopically displayed when the object to be stereoscopically displayed or the cursor to be stereoscopically displayed is stereoscopically viewed on a near side, and a reducing and rendering process is performed on the object to be stereoscopically displayed or the cursor to be stereoscopically displayed when the object to be stereoscopically displayed or the cursor to be stereoscopically displayed is stereoscopically viewed on a far side.

16. A stereoscopic image display apparatus for generating a stereoscopic image, comprising:
a means for rendering images of a plurality of viewpoints so as to stereoscopically display an object;
a means for performing a rendering process such that a cursor or an object is displayed in a moving manner on a screen according to operational information of a pointing device;
a means for determining whether there is an overlap of the object to be stereoscopically displayed, and the cursor or the object; and
a means for performing a rendering process such that the cursor or the object is not displayed when it is determined that there is the overlap.

17. A stereoscopic image display apparatus according to claim 16, wherein a rendering process is performed such that the cursor or the object is gradually erased.

18. A stereoscopic image display apparatus for generating a stereoscopic image, comprising:
a means for rendering images of a plurality of viewpoints so as to stereoscopically display an object;
a means for performing rendering process such that a cursor or an object is displayed in a moving manner on a screen according to operational information of a pointing device;
a means for determining whether there is an overlap of the object to be stereoscopically displayed, and the cursor or the object; and
a means for performing a rendering process such that a transparent cursor having only a contour or a transparent object having only a contour is displayed as the cursor or the object when it is determined that there is the overlap.

19. A stereoscopic image display apparatus for generating a stereoscopic image, comprising:
a means for rendering images of a plurality of viewpoints so as to stereoscopically display an object;
a means for performing a rendering process such that a cursor or an object is displayed in a moving manner on a screen according to operational information of a pointing device;
a means for determining whether there is an overlap of the object to be stereoscopically displayed, and the cursor or the object; and
a means for rendering all or a part of the cursor or the object by utilizing dot data of the object to be stereoscopically displayed when it is determined that there is the overlap.

20. A stereoscopic image display apparatus according to any one of claims 16 to 19, wherein an expanding and rendering process is performed on the object to be stereoscopically displayed when the object to be stereoscopically displayed is stereoscopically viewed on a near side, and a reducing and rendering process is performed on the object to be stereoscopically displayed when the object to be stereoscopically displayed is stereoscopically viewed on a far side.

21. A program for allowing a computer to function as:
a means for rendering images of a plurality of viewpoints so as to stereoscopically display an object;
a means for performing a rendering process such that a cursor or an object is displayed in a moving manner on a screen according to operational information of a pointing device;
a means for determining whether there is an overlap of the object to be stereoscopically displayed, and the cursor or the object; and
a means for rendering the images of a plurality of viewpoints of the cursor or the object such that the cursor or the object is stereoscopically viewed on a nearer side than the object to be stereoscopically displayed when it is determined that there is the overlap.

22. A program according to claim 21, wherein the computer is allowed to function as a means for performing an expanding and rendering process on an object to be stereoscopically displayed or a cursor to be stereoscopically displayed when the object to be stereoscopically displayed or the cursor to be stereoscopically displayed is stereoscopically viewed on a near side, and for performing a reducing and rendering process on the object to be stereoscopically displayed or the cursor to be stereoscopically displayed when the object to be stereoscopically displayed or the cursor to be stereoscopically displayed is stereoscopically viewed on a far side.

23. A program for allowing a personal computer to function as:
a means for rendering images of a plurality of viewpoints so as to stereoscopically display an object;
a means for performing a rendering process such that a cursor or an object is displayed in a moving manner on a screen according to operational information of a pointing device;
a means for determining whether there is an overlap of the object to be stereoscopically displayed, and the cursor or the object; and
a means for performing a rendering process such that the cursor or the object is not displayed when it is determined that there is the overlap.

24. A program according to claim 23, wherein the computer is allowed to function as a means for performing a rendering process such that the cursor or the object is gradually erased.

25. A program for allowing a computer to function as:
a means for rendering images of a plurality of viewpoints so as to stereoscopically display an object;
a means for performing a rendering process such that a cursor or an object is displayed in a moving manner on a screen according to operational information of a pointing device;
a means for determining whether there is an overlap of the object to be stereoscopically displayed, and the cursor or the object; and
a means for performing a rendering process such that a transparent cursor having only a contour or a transparent object having only a contour is displayed as the cursor or the object when it is determined that there is the overlap.

26. A program for allowing a computer to function as:
a means for rendering images of a plurality of viewpoints so as to stereoscopically display an object;
a means for performing a rendering process such that a cursor or an object is displayed in a moving manner on a screen according to operational information of a pointing device;
a means for determining whether there is an overlap of the object to be stereoscopically displayed, and the cursor or the object; and
a means for rendering all or a part of the cursor or the object by utilizing dot data of the object to be stereoscopically displayed when it is determined that there is the overlap.

27. A program according to any one of claims 23 to 26, wherein the computer is allowed to function as a means for performing an expanding and rendering process on an object to be stereoscopically displayed when the object to be stereoscopically displayed is stereoscopically viewed on a near side, and for performing a reducing and rendering process on the object to be stereoscopically displayed when the object to be stereoscopically displayed is stereoscopically viewed on a far side.
